(19) United States
(12) Patent Application Publication
(10) Pub. No.: US 2025/0096440 A1
(43) Pub. Date: Mar. 20, 2025

(54) ENERGY STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/748,686

(22) Filed: Jun. 20, 2024

(30) Foreign Application Priority Data
Sep. 19, 2023 (JP) 2023-151064

(51) Int. Cl. H01M 50/586; H01M 10/04; H01M 10/658; H01M 50/107; H01M 50/583

(52) U.S. Cl. CPC H01M 50/586; H01M 10/0431; H01M 10/658; H01M 50/107; H01M 50/583; H01M 2200/103

(57) ABSTRACT

In the energy storage cell according to the present disclosure, the first wound electrode assembly includes a first positive electrode and a first negative electrode. The second wound electrode assembly includes a second positive electrode and a second negative electrode. The second positive electrode is not in contact with the first positive electrode. The second negative electrode is not in contact with the first negative electrode. The second wound electrode assembly is formed by winding around the first wound electrode assembly on the outer peripheral side of the first wound electrode assembly. The positive electrode current collector member is electrically connected to both the first positive electrode and the second positive electrode. The negative electrode current collector member is electrically connected to both the first negative electrode and the second negative electrode.

### CROSS-REFERENCE TO RELATED APPLICATION

This application claims priority to Japanese Patent Application No. 2023-151064 filed on Sep. 19, 2023, incorporated herein by reference in its entirety.

### BACKGROUND

### 1. Technical Field

The present disclosure relates to energy storage cells.

### 2. Description of Related Art

Japanese Unexamined Patent Application Publication No. 11-273743 (JP 11-273743 A) discloses a cylindrical non-aqueous electrolyte secondary cell. In the cylindrical non-aqueous electrolyte secondary cell, a spiral electrode assembly together with a non-aqueous electrolyte solution is housed in a cylindrical cell can.

### SUMMARY

For example, in an energy storage cell such as the secondary cell disclosed in JP 11-273743 A, a pressure may be applied to a case from the outer peripheral side of the case. In this case, the case is deformed, so that the case further presses an electrode assembly contained therein. As a result, the electrode assembly is compressed, which may affect the original function of the energy storage cell. There is room for improvement in reliability of the energy storage cell.

The present disclosure was made in view of the above problem, and an object of the present disclosure is to provide an energy storage cell with improved reliability.

An energy storage cell according to the present disclosure includes a first wound electrode assembly, a second wound electrode assembly, a case, a positive electrode current collector member, and a negative electrode current collector member. The first wound electrode assembly includes a first positive electrode and a first negative electrode. The second wound electrode assembly includes a second positive electrode and a second negative electrode. The second positive electrode is not in contact with the first positive electrode. The second negative electrode is not in contact with the first negative electrode. The second wound electrode assembly is wound around an outer periphery of the first wound electrode assembly about the first wound electrode assembly. The case houses the first wound electrode assembly and the second wound electrode assembly. The positive electrode current collector member is housed in the case. The positive electrode current collector member is disposed on one side of the first wound electrode assembly and the second wound electrode assembly in an axial direction of the first wound electrode assembly. The positive electrode current collector member is electrically connected to both the first positive electrode and the second positive electrode. The negative electrode current collector member is housed in the case. The negative electrode current collector member is disposed on another side of the first wound electrode assembly and the second wound electrode assembly in the axial direction. The negative electrode current collector member is electrically connected to both the first negative electrode and the second negative electrode.

With the above configuration, even when a pressure is applied to the case from the outer peripheral side of the case and the second wound electrode assembly is broken, the first wound electrode assembly may function normally together with the positive electrode current collector member and the negative electrode current collector member. Reliability of the energy storage cell is thus improved.

The present disclosure can provide an energy storage cell with improved reliability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating an energy storage cell according to an embodiment;

FIG. 2 is a perspective view showing a first wound electrode assembly, a second wound electrode assembly, and a heat insulating member partially disassembled;

FIG. 3 is an exploded perspective view illustrating an energy storage cell according to an embodiment; and

FIG. 4 is another exploded perspective view illustrating an energy storage cell according to an embodiment.

### DETAILED DESCRIPTION OF EMBODIMENTS

Hereinafter, an energy storage cell according to an embodiment of the present disclosure will be described with reference to the drawings. The same or corresponding parts in the drawings are denoted by the same reference numerals, and the description thereof will not be repeated.

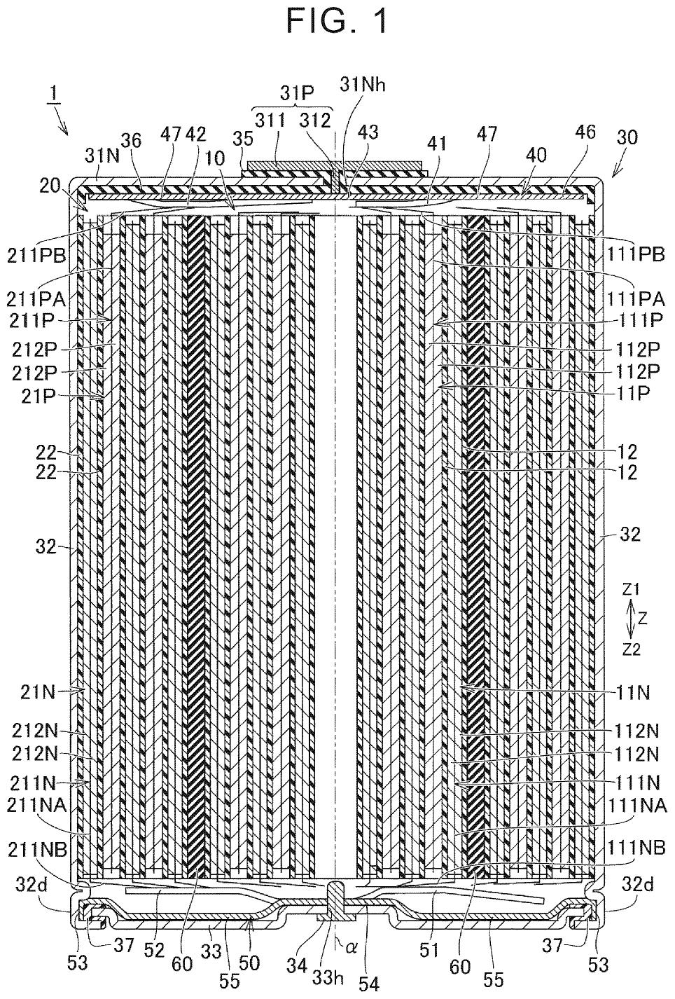

FIG. 1 is a cross-sectional view illustrating an energy storage cell according to an embodiment. As shown in FIG. 1, an energy storage cell 1 according to an embodiment of the present disclosure is a cylindrical cell. The energy storage cell 1 includes a first wound electrode assembly 10, a second wound electrode assembly 20, a case 30, a positive electrode current collector member 40, a negative electrode current collector member 50, and a heat insulating member 60.

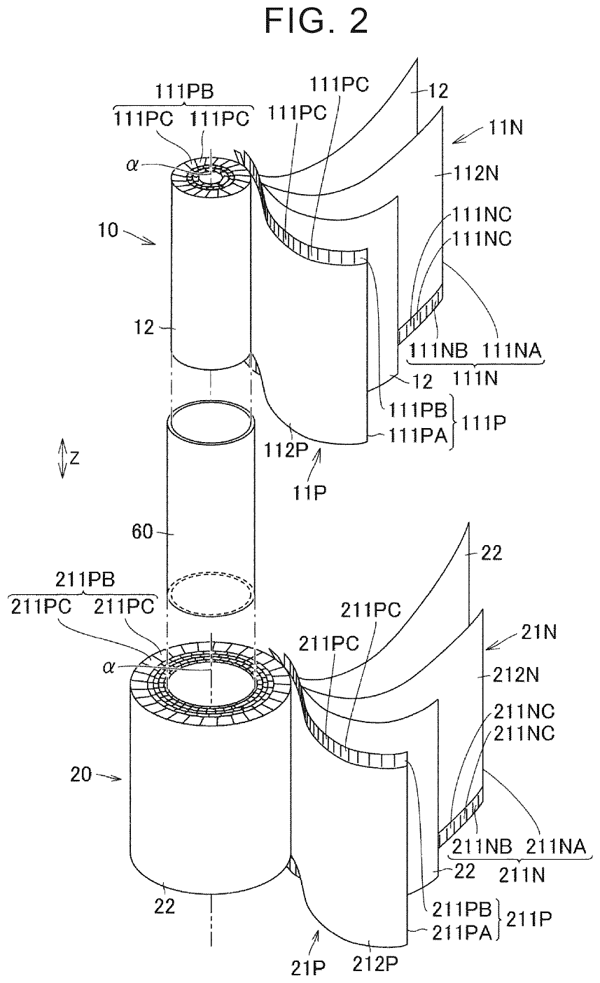

First, the first wound electrode assembly 10 will be described. FIG. 2 is a perspective view illustrating the first wound electrode assembly, the second wound electrode assembly, and the heat insulating member partially disassembled. As shown in FIGS. 1 and 2, the first wound electrode assembly 10 is wound so as to have a cylindrical shape. FIG. 2 illustrates a state in which the winding of the first wound electrode assembly 10 is slightly unwound.

The first wound electrode assembly 10 includes a first positive electrode 11P, a first negative electrode 11N, and a first separator 12. The first wound electrode assembly 10 is wound such that the first positive electrode 11P, the first negative electrode 11N, and the first separator 12 surround the winding shaft line a.

The first positive electrode 11P and the first negative electrode 11N have a sheet-like outer shape. The first wound electrode assembly 10 includes an electrode plate group in which the first positive electrode 11P and the first negative electrode 11N are wound with the first separator 12 interposed therebetween.

The first separator 12 is provided between the first positive electrode 11P and the first negative electrode 11N. The first separator 12 separates the first positive electrode 11P and the first negative electrode 11N while allowing ions (e.g., lithium ions) to move back and forth between the first positive electrode 11P (positive electrode active material) and the first negative electrode 11N (negative electrode active material).

The first positive electrode 11P includes a first positive electrode collector foil 111P and a first positive electrode mixture 112P. The first positive electrode collector foil 111P is made of, for example, aluminum.

The first positive electrode mixture layers 112P are coated on both radial surfaces of a first positive electrode collector foil 111P (a first positive electrode coating portion 111PA described later). The first positive electrode mixture layers 112P are in close contact with the first separator 12. The first positive electrode mixture layers 112P are formed by coating the positive electrode slurry on the first positive electrode current collector foil 111P and drying it. The positive electrode slurry is a slurry prepared by kneading a material (a positive electrode active material, a binder, or the like) on 112P of the first positive electrode mixture layers and solvents. The thickness of the first positive electrode mixture layers 112P is, for example, 0.1 μm or more and 1000 μm or less.

The first positive electrode current collector foil 111P includes a first positive electrode coated portion 111PA and a first positive electrode uncoated portion 111PB. The first positive electrode coating portion 111PA is a portion of the first positive electrode current collector foil 111P on which the first positive electrode mixture layers 112P are coated. In other words, the first positive electrode coating portion 111PA is not exposed by being covered with the first positive electrode mixture layers 112P.

The first positive electrode uncoated portion 111PB is not covered with the first positive electrode mixture layers 112P and is exposed in the first positive electrode collector foil 111P. The first positive electrode uncoated portion 111PB is located closer to the first direction Z1 along the axial direction Z than the first positive electrode coated portion 111PA. Specifically, the first positive electrode uncoated portion 111PB protrudes from the first positive electrode coated portion 111PA toward the first directional Z1. The first positive electrode uncoated portion 111PB is bent radially inward.

The first positive electrode uncoated portion 111PB includes a plurality of extension portions 111PC. The plurality of extending portions 111PC are arranged along the winding direction of the first wound electrode assembly 10.

The first negative electrode 11N includes a first negative electrode current collector foil 111N and a first negative electrode mixture 112N. The first negative electrode collector foil 111N is made of, for example, copper.

The first negative electrode mixture layers 112N are coated on both radial surfaces of the first negative electrode collector foil 111N (a first negative electrode coating portion 111NA described later). The first negative electrode mixture layers 112N are in close contact with the first separator 12. The first negative electrode mixture layers 112N are formed by coating the negative electrode slurry on the first negative electrode collector foil 111N and drying it. The negative electrode slurry is a slurry prepared by kneading a material (a negative electrode active material, a binder, or the like) of the first negative electrode mixture layer 112N and solvents. The thickness of the first negative electrode mixture layer 112N is, for example, 0.1 μm or more and 1000 μm or less.

The first negative electrode current collector foil 111N includes a first negative electrode coating portion 111NA and a first negative electrode uncoated portion 111NB. The first negative electrode coating portion 111NA is a portion of the first negative electrode current collector foil 111N on which the first negative electrode mixture layers 112N are coated. In other words, the first negative electrode coating portion 111NA is not exposed by being covered with the first negative electrode mixture layers 112N.

The first negative electrode uncoated portion 111NB is a portion of the first negative electrode current collector foil 111N that is not covered by the first negative electrode mixture layers 112N and is exposed. The first negative electrode uncoated portion 111NB is located closer to the second direction Z2 along the axial direction than the first negative electrode coated portion 111NA. The second direction Z2 is opposite the first direction Z1. The first negative electrode uncoated portion 111NB protrudes from the first negative electrode coated portion 111NA toward the second direction Z2 along the axial direction Z. The first negative electrode uncoated portion 111NB is bent radially inward.

The first negative electrode uncoated portion 111NB includes a plurality of extending portions 111NC. The plurality of extending portions 111NC are arranged along the winding direction of the first wound electrode assembly 10.

Next, the second wound electrode assembly 20 will be described. As shown in FIGS. 1 and 2, the second wound electrode assembly 20 is formed by being wound around the first wound electrode assembly 10 on the outer peripheral side of the first wound electrode assembly 10. The second wound electrode assembly 20 is wound so as to have a cylindrical shape. FIG. 2 illustrates a state in which the winding of the second wound electrode assembly 20 is slightly unwound.

The second wound electrode assembly 20 includes a second positive electrode 21P, a second negative electrode 21N, and a second separator 22. In the second wound electrode assembly 20, the second positive electrode 21P, the second negative electrode 21N, and the second separator 22 are wound so as to surround the winding shaft line a in the same manner as the first wound electrode assembly 10.

The second positive electrode 21P is not in contact with the first positive electrode 11P. The second positive electrode 21P is formed of a member that is discontinuous with the first positive electrode 11P. The second negative electrode 21N is not in contact with the first negative electrode 11N. The second negative electrode 21N is formed of a member that is discontinuous with the first negative electrode 11N. In the present embodiment, the second separator 22 is formed of a member that is discontinuous with the first separator 12. However, the second separator 22 may be formed of an integral member together with the first separator 12.

Except for the configuration described above, the second wound electrode assembly 20 may have the same configuration as the first wound electrode assembly 10. Except for the configuration described above, the second positive electrode 21P, the second negative electrode 21N, and the second separator 22 with respect to the second wound electrode assembly 20 have the same configuration as the first positive electrode 11P, the first negative electrode 11N, and the first separator 12 with respect to the first wound electrode assembly 10.

The second positive electrode 21P includes a second positive electrode collector foil 211P and a second positive electrode mixture 212P. The second positive electrode collector foil 211P and the second positive electrode mixture layer 212P with respect to the second positive electrode 21P have the same configuration as the first positive electrode collector foil 111P and the first positive electrode mixture layer 112P with respect to the first positive electrode 11P. The second positive electrode current collector foil 211P includes a second positive electrode coated portion 211PA and a second positive electrode uncoated portion 211PB. The second positive electrode coated portion 211PA and the second positive electrode uncoated portion 211PB with respect to the second positive electrode collector foil 211P have the same configuration as the first positive electrode coated portion 111PA and the first positive electrode uncoated portion 111PB with respect to the first positive electrode collector foil 111P. The second positive electrode uncoated portion 211PB, like the first positive electrode uncoated portion 111PB, includes a plurality of extending portion 211PC.

The second negative electrode 21N includes a second negative electrode current collector foil 211N and a second negative electrode mixture 212N. The second negative electrode collector foil 211N and the second negative electrode mixture layer 212N with respect to the second negative electrode 21N have the same configuration as the first negative electrode collector foil 111N and the first negative electrode mixture layer 112N with respect to the first negative electrode 11N. The second negative electrode current collector foil 211N includes a second negative electrode coating portion 211NA and a second negative electrode uncoated portion 211NB. The second negative electrode coating portion 211NA and the second negative electrode uncoated portion 211NB for the second negative electrode current collector foil 211N have the same configuration as the first negative electrode coating portion 111NA and the first negative electrode uncoated portion 111NB for the first negative electrode current collector foil 111N. The second negative electrode uncoated portion 211NB includes a plurality of extension portions 211NC in the same manner as the plurality of extension portions 111NC with respect to the first negative electrode uncoated portion 111NB.

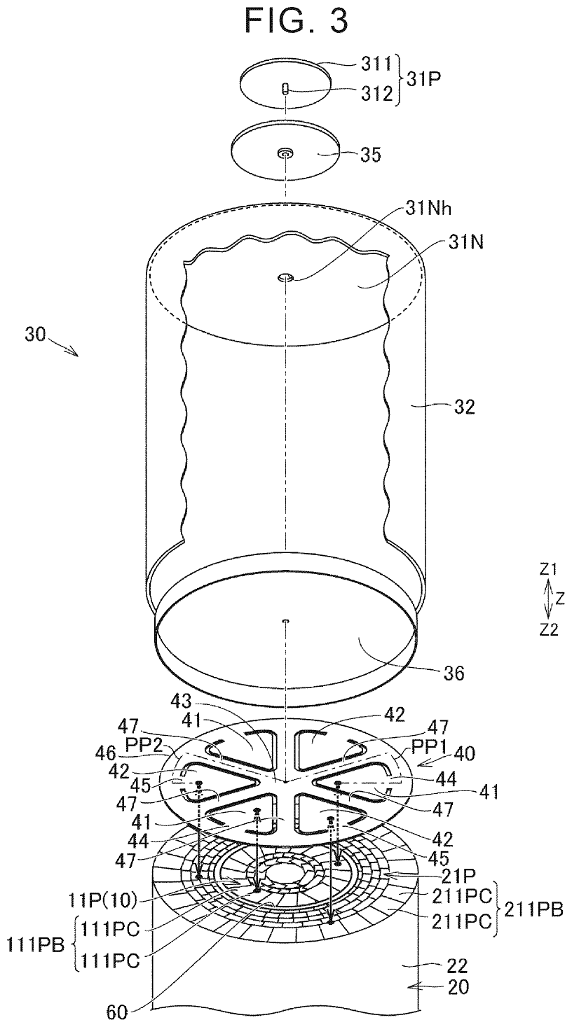

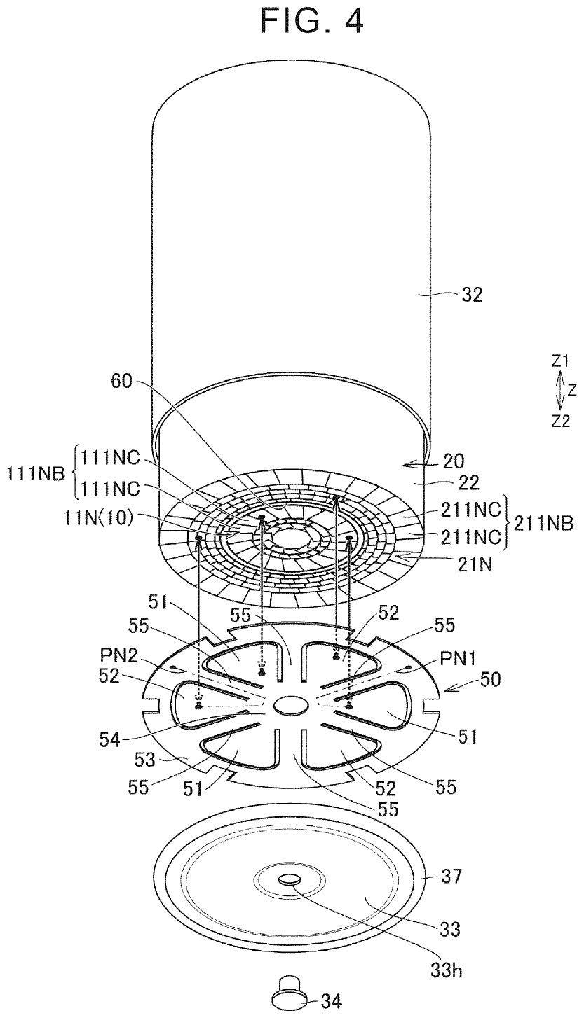

Next, the case 30 will be described. FIG. 3 is an exploded perspective view illustrating an energy storage cell according to an embodiment. FIG. 4 is another exploded perspective view illustrating an energy storage cell according to an embodiment. As shown in FIGS. 1, 3, and 4, the case 30 houses the first wound electrode assembly 10 and the second wound electrode assembly 20.

The case 30 includes a positive electrode terminal 31P, a negative electrode terminal 31N, a tubular wall portion 32, a sealing plate 33, a sealing plug 34, an outer gasket 35, an inner gasket 36, and an annular gasket 37.

The positive electrode terminal 31P is exposed to the outside of the case 30. The positive electrode terminal 31P is disposed on the first direction Z1 side of the first wound electrode assembly 10. The positive electrode terminal 31P includes a disc portion 311 and a rivet portion 312. The disc portion 311 is exposed to the outside. The rivet portion 312 is connected to the disc portion 311. The rivet portion 312 extends from the center of the disc portion 311 when viewed in the axial direction Z. The rivet portion 312 is located approximately on the winding axis a of the first wound electrode assembly 10. The rivet portion 312 extends toward the Z2 side in the second direction. The positive electrode terminal 31P is made of, for example, aluminum.

The negative electrode terminal 31N is provided so as to be perpendicular to the axial direction Z. The negative electrode terminal 31N is provided with a through-hole 31Nh. Therefore, the negative electrode terminal 31N has a ring-shaped outer shape when viewed from the axial direction Z. The negative electrode terminal 31N is positioned between the disc portion 311 and the first wound electrode assembly 10 and the second wound electrode assembly 20 in the axial direction Z. The rivet portion 312 is inserted through the through-hole 31Nh. The rivet portion 312 extends to the inside of the case 30. The negative electrode terminal 31N is made of aluminum, copper, stainless steel, or the like.

The tubular wall portion 32 is provided on the outer peripheral side of the second wound electrode assembly 20. The tubular wall portion 32 covers the entire outer peripheral side of the second wound electrode assembly 20. The tubular wall portion 32 has a cylindrical shape. An end portion of the tubular wall portion 32 to the first direction Z1 side is connected to the negative electrode terminal 31N. The tubular wall portion 32 is formed integrally with the negative electrode terminal 31N. The material constituting the tubular wall portion 32 is not particularly limited, but is made of aluminum, copper, stainless steel, or the like.

A crimped portion 32d is formed at an end portion of the tubular wall portion 32 to the second direction Z2 side. The crimped portion 32d is annularly formed along the circumference of the second wound electrode assembly 20. In FIG. 4, the tubular wall portion 32 is shown before the crimped portion 32d is formed.

The sealing plate 33 is connected to the end on the second direction Z2 side of the tubular wall portion 32. The sealing plate 33 seals the opening on the second direction Z2 side of the tubular wall portion 32. The crimped portion 32d is caulked to the outer peripheral edge of the sealing plate 33. The sealing plate 33 may be connected to the tubular wall portion 32 by welding such as laser welding. The material constituting the sealing plate 33 is not particularly limited, but is made of aluminum, copper, stainless steel, or the like.

A through-hole 33h is formed in the sealing plate 33. The through-hole 33h may be used to inject an electrolyte (not shown) contained in the case 30. The through-hole 33h is formed in the center of the sealing plate 33 when viewed from the axial direction Z.

The sealing plug 34 is inserted through the through-hole 33h of the sealing plate 33. Thus, the sealing plug 34 is fixed to the sealing plate 33. The sealing plug 34 and the through-hole 33h may function as a pressure relief valve for relieving the pressure inside the case 30 when the pressure inside the case 30 becomes excessively high.

The outer gasket 35 is disposed between the positive electrode terminal 31P and the negative electrode terminal 31N. The outer gasket 35 is made of an insulating material. Therefore, the outer gasket 35 insulates the positive electrode terminal 31P from the negative electrode terminal 31N. The outer gasket 35 covers the surface on the second direction Z2 side of the disc portion 311. The rivet portion 312 penetrates the outer gasket 35 in the axial direction Z. The outer gasket 35 covers a radial inner surface of the through-hole 31Nh of the negative electrode terminal 31N.

The inner gasket 36 covers the surface on the second direction Z2 side of the negative electrode terminal 31N. The inner gasket 36 is formed of an insulating material. Therefore, the inner gasket 36 insulates the first wound electrode assembly 10 and the second wound electrode assembly 20 from the negative electrode terminal 31N. The rivet portion 312 further penetrates the inner gasket 36 in the axial direction Z. Therefore, the rivet portion 312 is exposed inside the case 30.

The annular gasket 37 has an annular outer shape. The annular gasket 37 covers the outer peripheral edge of the sealing plate 33. The annular gasket 37 is disposed between the outer peripheral edge of the sealing plate 33 and the crimped portion 32d of the tubular wall portion 32. The annular gasket 37 may be formed of an insulating material or a conductive material. Note that the case 30 may not include the annular gasket 37.

In the present embodiment, the sealing plate 33 is insulated from the tubular wall portion 32 by the annular gasket 37, but the sealing plate 33 may be electrically connected to the tubular wall portion 32. In this case, the sealing plate 33 may be a negative electrode terminal.

In addition, in the present embodiment, a part of the case 30 facing the first direction Z1 is constituted by the positive electrode terminal 31P, the negative electrode terminal 31N, and the outer gasket 35. However, as part of the above-described portion, the case 30 may further include a top plate portion. The top plate portion may be located further on the inner periphery of the negative electrode terminal 31N, for example. The top plate portion may be arranged to be aligned with the positive electrode terminal 31P in the axial direction Z. The top plate portion may be insulated from the negative electrode terminal 31N. When the sealing plate 33 serves as a negative electrode terminal as described above, a top plate portion electrically insulated from the sealing plate 33 and the tubular wall portion 32 may be disposed instead of the negative electrode terminal 31N.

Next, the positive electrode current collector member 40 will be described. As shown in FIGS. 1 and 3, the positive electrode current collector member 40 is accommodated in the case 30. The positive electrode current collector member 40 is disposed on the first direction Z1 side of the first wound electrode assembly 10 and the second wound electrode assembly 20 in the axial direction Z of the first wound electrode assembly 10.

An inner gasket 36 is disposed between the positive electrode current collector member 40 and the negative electrode terminal 31N. As a result, the positive electrode current collector member 40 and the negative electrode terminal 31N are electrically insulated from each other. Further, the inner gasket 36 extends to the outer peripheral side of the positive electrode current collector member 40. As a result, the inner gasket 36 is also disposed between the positive electrode current collector member 40 and the tubular wall portion 32. Therefore, the positive electrode current collector member 40 and the tubular wall portion 32 are electrically insulated from each other.

The positive electrode current collector member 40 has a plate-like outer shape. The positive electrode current collector member 40 has a substantially disk-shaped outer shape. The positive electrode current collector member 40 includes a plurality of first positive electrode connection portions 41, a plurality of second positive electrode connection portions 42, a terminal connection portion 43, a plurality of first fuse portions 44, a plurality of second fuse portions 45, an outer peripheral edge portion 46, and a plurality of positive electrode spoke portions 47.

Each of the plurality of first positive electrode connection portions 41 is connected to the first positive electrode 11P. Specifically, each of the plurality of first positive electrode connection portions 41 is welded to the first positive electrode uncoated portion 111PB of the first positive electrode 11P. The plurality of first positive electrode connection portions 41 are spaced apart from each other. The plurality of first positive electrode connection portions 41 are arranged at equal intervals in the circumferential direction around the terminal connection portion 43.

Each of the plurality of second positive electrode connection portions 42 is connected to the second positive electrode 21P. Specifically, each of the plurality of second positive electrode connection portions 42 is welded to the second positive electrode uncoated portion 211PB of the second positive electrode 21P. The plurality of second positive electrode connection portions 42 are spaced apart from each other. The plurality of second positive electrode connection portions 42 are arranged at equal intervals in the circumferential direction around the terminal connection portion 43. The plurality of first positive electrode connection portions 41 and the plurality of second positive electrode connection portions 42 are alternately arranged in the circumferential direction.

The terminal connection portion 43 is connected to the positive electrode terminal 31P. Specifically, the terminal connection portion 43 is welded to the rivet portion 312 of the positive electrode terminal 31P. Thus, in the present embodiment, the positive electrode terminal 31P is electrically connected to the positive electrode current collector member 40. The terminal connection portion 43 is positioned so as to overlap with the rivet portion 312 of the positive electrode terminal 31P when viewed from the axial direction Z. The terminal connection portion 43 is electrically connected to the first positive electrode connection portion 41 and the second positive electrode connection portion 42. However, in the present embodiment, the terminal connection portion 43 is disposed so as to be separated from the first positive electrode connection portion 41 and the second positive electrode connection portion 42.

The plurality of first fuse portions 44 are connected to each of the plurality of first positive electrode connection portions 41. Each of the first fuse portions 44 is located opposite to the terminal connection portion 43 when viewed from the corresponding first positive electrode connection portion 41. The dimension of the first fuse portion 44 in the circumferential direction is smaller than the dimension of the edge facing the outer peripheral side of the first positive electrode connection portion 41 in the circumferential direction. The thickness of the first fuse portion 44 is preferably smaller than the thickness of the first positive electrode connection portion 41.

The plurality of second fuse portions 45 are connected to each of the plurality of second positive electrode connection portions 42. Each of the second fuse portions 45 is located opposite to the terminal connection portion 43 when viewed from the corresponding second positive electrode connection portion 42. The dimension of the second fuse portion 45 in the circumferential direction is smaller than the dimension of the edge facing the outer peripheral side of the second positive electrode connection portion 42 in the circumferential direction. The thickness of the second fuse portion 45 is preferably smaller than the thickness of the second positive electrode connection portion 42.

The outer peripheral edge portion 46 is provided on the outer peripheral edge of the positive electrode current collector member 40. The outer peripheral edge portion 46 is further provided on the outer peripheral side of the plurality of first positive electrode connection portions 41 and the plurality of second positive electrode connection portions 42. The outer peripheral edge portion 46 is spaced apart from the plurality of first positive electrode connection portions 41 and the plurality of second positive electrode connection portions 42. The outer peripheral edge portion 46 is connected to the plurality of first fuse portions 44 and the plurality of second fuse portions 45. The outer peripheral edge portion 46 extends in an annular shape around the terminal connection portion 43.

The plurality of positive electrode spoke portions 47 are spaced apart from each other. Each of the plurality of positive electrode spoke portions 47 connects the terminal connection portion 43 and the outer peripheral edge portion 46. Each of the plurality of positive electrode spoke portions 47 extends in the radial direction around the terminal connection portion 43. Each of the plurality of positive electrode spoke portions 47 is disposed between the first positive electrode connection portions 41 and the second positive electrode connection portions 42 adjacent to each other in the circumferential direction.

Therefore, the electrically conductive path PP1 from the first positive electrode connection portion 41 to the terminal connection portion 43 in the positive electrode current collector member 40 passes through the first fuse portion 44, the outer peripheral edge portion 46, and the positive electrode spoke portion 47 (see FIG. 3). The first fuse portion 44 is disposed in the electrically conductive path PP1 from the first positive electrode connection portion 41 to the terminal connection portion 43 in the positive electrode current collector member 40.

In addition, the electrically conductive path PP2 from the second positive electrode connection portion 42 to the terminal connection portion 43 in the positive electrode current collector member 40 passes through the second fuse portion 45, the outer peripheral edge portion 46, and the positive electrode spoke portion 47 (see FIG. 3). The second fuse portion 45 is disposed in the electrically conductive path PP2 from the second positive electrode connection portion 42 to the terminal connection portion 43 in the positive electrode current collector member 40.

The first fuse portion 44 is provided so as not to be positioned on the electrically conductive path PP2 from the second positive electrode connection portion 42 to the terminal connection portion 43 in the positive electrode current collector member 40. The second fuse portion 45 is provided so as not to be positioned on the electrically conductive path PP1 from the first positive electrode connection portion 41 to the terminal connection portion 43 in the positive electrode current collector member 40.

In the present embodiment, the positive electrode current collector member 40 is electrically connected to both the first positive electrode 11P and the second positive electrode 21P by having the above configuration. As a result, the positive electrode current collector member 40 is positively charged. The positive electrode current collector member 40 is electrically connected to the positive electrode terminal 31P. As a result, the positive electrode terminal 31P is positively charged.

Note that the positive electrode current collector member 40 is not limited to the above-described plate-shaped member. The positive electrode current collector member 40 may be composed of a plurality of tab leads. One tab lead may electrically connect the first positive electrode 11P and the positive electrode terminal 31P, and another tab lead may electrically connect the second positive electrode 21P and the positive electrode terminal 31P. Further, the first fuse portion 44 may be provided in one tab lead, and the second fuse portion 45 may be provided in another tab lead.

Next, the negative electrode current collector member 50 will be described. As shown in FIGS. 1 and 4, the negative electrode current collector member 50 is accommodated in the case 30. The negative electrode current collector member 50 is disposed on the second direction Z2 side of the first wound electrode assembly 10 and the second wound electrode assembly 20 in the axial direction Z. The negative electrode current collector member 50 is electrically connected to both the first negative electrode 11N and the second negative electrode 21N. The configuration of the negative electrode current collector member 50 is not particularly limited.

The negative electrode current collector member 50 in the present embodiment is joined to the tubular wall portion 32 by being crimped together with the outer peripheral edge of the sealing plate 33 and the annular gasket 37 at the crimped portion 32d.

The negative electrode current collector member 50 has a plate-like outer shape. The negative electrode current collector member 50 has a substantially disk-shaped outer shape. The negative electrode current collector member 50 includes a plurality of first negative electrode connection portions 51, a plurality of second negative electrode connection portions 52, a case connection portion 53, a central portion 54, and a plurality of negative electrode spoke portions 55.

Each of the plurality of first negative electrode connection portions 51 is connected to the first negative electrode 11N. Specifically, each of the plurality of first negative electrode connection portions 51 is welded to the first negative electrode uncoated portion 111NB of the first negative electrode 11N. The plurality of first negative electrode connection portions 51 are spaced apart from each other. The plurality of first negative electrode connection portions 51 are arranged at equal intervals in the circumferential direction around the central portion 54.

Each of the plurality of second negative electrode connection portions 52 is connected to the second negative electrode 21N. Specifically, each of the plurality of second negative electrode connection portions 52 is welded to the second negative electrode uncoated portion 211NB of the second negative electrode 21N. The plurality of second negative electrode connection portions 52 are spaced apart from each other. The plurality of second negative electrode connection portions 52 are arranged at equal intervals in the circumferential direction around the central portion 54. The plurality of first negative electrode connection portions 51 and the plurality of second negative electrode connection portions 52 are alternately arranged in the circumferential direction.

The case connection portion 53 is connected to the tubular wall portion 32. Specifically, the case connection portion 53 is joined to the tubular wall portion 32 by being caulked together with the outer peripheral edge of the sealing plate 33 and the annular gasket by the crimped portion 32d. Thus, in the present embodiment, the negative electrode terminal 31N is electrically connected to the negative electrode current collector member 50 via the tubular wall portion 32. The case connection portion 53 is provided on the outer peripheral edge of the negative electrode current collector member 50. The case connection portion 53 is further provided on the outer peripheral side of the plurality of first negative electrode connection portions 51 and the plurality of second negative electrode connection portions 52. The case connection portion 53 is separated from the plurality of first negative electrode connection portions 51 and the plurality of second negative electrode connection portions 52. The case connection portion 53 extends in an annular shape around the central portion 54.

The central portion 54 is positioned so as to overlap with the first wound electrode assembly 10 in the axial direction Z. The central portion 54 is provided on the inner peripheral side of the plurality of first negative electrode connection portions 51 and the plurality of second negative electrode connection portions 52. The central portion 54 is connected to the plurality of first negative electrode connection portions 51 and the plurality of second negative electrode connection portions 52.

The plurality of negative electrode spoke portions 55 are spaced apart from each other. Each of the plurality of negative electrode spoke portions 55 connects the central portion 54 and the case connection portion 53. Each of the plurality of negative electrode spoke portions 55 extends in the radial direction around the central portion 54. Each of the plurality of negative electrode spoke portions 55 is disposed between the first negative electrode connection portions 51 and the second negative electrode connection portions 52 adjacent to each other in the circumferential direction.

Therefore, the electrically conductive path PN1 from the first negative electrode connection portion 51 to the case connection portion 53 and the conductive path PN2 from the second negative electrode connection portion 52 to the case connection portion 53 in the negative electrode current collector member 50 both pass through the central portion 54 and the negative electrode spoke portion 55.

Note that the negative electrode current collector member 50 is not limited to the above-described plate-shaped member. The negative electrode current collector member 50 may be composed of a plurality of tab leads. One tab lead may electrically connect the first negative electrode 11N and the negative electrode terminal 31N, and another tab lead may electrically connect the second negative electrode 21N and the negative electrode terminal 31N. When the sealing plate 33 serves as a negative electrode terminal or when the sealing plate 33 is electrically connected to the negative electrode terminal 31N, the first negative electrode 11N and the second negative electrode 21N may be directly bonded to the sealing plate 33 by welding or the like.

Finally, the heat insulating member 60 will be described. As illustrated in FIGS. 1 to 4, the heat insulating member 60 has a tubular outer shape. The heat insulating member 60 is disposed between the first wound electrode assembly 10 and the second wound electrode assembly 20 in the radial direction of the first wound electrode assembly 10. The heat insulating member 60 is preferably formed of an electrically insulating member. As the heat insulating member 60, for example, a resin composition such as a foamed resin can be employed.

As described above, the energy storage cell 1 according to an embodiment of the present disclosure includes the first wound electrode assembly 10, the second wound electrode assembly 20, the case 30, the positive electrode current collector member 40, and the negative electrode current collector member 50. The first wound electrode assembly 10 includes a first positive electrode 11P and a first negative electrode 11N. The second wound electrode assembly 20 includes a second positive electrode 21P and a second negative electrode 21N. The second positive electrode 21P is not in contact with the first positive electrode 11P. The second negative electrode 21N is not in contact with the first negative electrode 11N. The second wound electrode assembly 20 is formed by being wound around the first wound electrode assembly 10 on the outer peripheral side of the first wound electrode assembly 10. The case 30 houses the first wound electrode assembly 10 and the second wound electrode assembly 20. The positive electrode current collector member 40 is accommodated in the case 30. The positive electrode current collector member 40 is disposed on one side of the first wound electrode assembly 10 and the second wound electrode assembly 20 in the axial direction Z of the first wound electrode assembly 10. The positive electrode current collector member 40 is electrically connected to both the first positive electrode 11P and the second positive electrode 21P. The negative electrode current collector member 50 is accommodated in the case 30. The negative electrode current collector member 50 is disposed on the other side of the first wound electrode assembly 10 and the second wound electrode assembly 20 in the axial direction Z. The negative electrode current collector member 50 is electrically connected to both the first negative electrode 11N and the second negative electrode 21N.

According to the above configuration, even when pressure is applied to the case 30 from the outer peripheral side of the case 30 and the second wound electrode assembly 20 is broken, the first wound electrode assembly 10 can function normally together with the positive electrode current collector member 40 and the negative electrode current collector member 50. This further improves the reliability of the energy storage cell 1.

In the present embodiment, the case 30 includes a positive electrode terminal 31P. The positive electrode terminal 31P is exposed to the outside of the case 30. The positive electrode terminal 31P is electrically connected to the positive electrode current collector member 40. The positive electrode current collector member 40 includes a first positive electrode connection portion 41, a second positive electrode connection portion 42, a terminal connection portion 43, and a first fuse portion 44. The first positive electrode connection portion 41 is connected to the first positive electrode 11P. The second positive electrode connection portion 42 is connected to the second positive electrode 21P. The terminal connection portion 43 is connected to the positive electrode terminal 31P. The first fuse portion 44 is disposed in the electrically conductive path PP1 from the first positive electrode connection portion 41 to the terminal connection portion 43 in the positive electrode current collector member 40.

Since the first wound electrode assembly 10 is located on the inner peripheral side of the second wound electrode assembly 20, it is relatively difficult to dissipate heat. However, according to the above-described configuration, when the first wound electrode assembly 10 generates excessive heat, the first fuse portion 44 is cut. A short circuit in the first wound electrode assembly 10 is suppressed. This further improves the safety of the energy storage cell 1.

In the present embodiment, the positive electrode current collector member 40 includes a second fuse portion 45. The second fuse portion 45 is disposed in the electrically conductive path PP2 from the second positive electrode connection portion 42 to the terminal connection portion 43 in the positive electrode current collector member 40.

According to the above configuration, when the second wound electrode assembly 20 is crushed and an excessive current flows through the second wound electrode assembly 20, the second fuse portion 45 is cut. A short circuit in the second wound electrode assembly 20 is suppressed. This further improves the safety of the energy storage cell 1.

In addition, in the present embodiment, the first fuse portion 44 is provided so as not to be positioned on the electrically conductive path PP2 from the second positive electrode connection portion 42 to the terminal connection portion 43 in the positive electrode current collector member 40. The second fuse portion 45 is provided so as not to be positioned on the electrically conductive path PP1 from the first positive electrode connection portion 41 to the terminal connection portion 43 in the positive electrode current collector member 40.

According to the above configuration, the short circuit in the first wound electrode assembly 10 and the short circuit in the second wound electrode assembly 20 are individually suppressed. This further improves both the reliability and the safety of the energy storage cell 1.

In the present embodiment, the energy storage cell 1 further includes a tubular heat insulating member 60. The heat insulating member 60 is disposed between the first wound electrode assembly 10 and the second wound electrode assembly 20 in the radial direction of the first wound electrode assembly 10.

According to the above configuration, when the first wound electrode assembly 10 excessively generates heat, it is possible to prevent the heat generated from the first wound electrode assembly 10 from being transmitted to the second wound electrode assembly 20. The first fuse portion 44 is cut. A short circuit in the first wound electrode assembly 10 is suppressed. Accordingly, the second wound electrode assembly 20 can function normally together with the positive electrode current collector member 40 and the negative electrode current collector member 50. This further improves the reliability of the energy storage cell 1.

The embodiments disclosed herein are to be considered in all respects as illustrative and not restrictive. The scope of the present disclosure is indicated by the claims rather than the description of the embodiment described above, and it is intended that all changes within the meaning and scope equivalent to the claims are included.

What is claimed is:

1. An energy storage cell, comprising:
a first wound electrode assembly including a first positive electrode and a first negative electrode;
a second wound electrode assembly including a second positive electrode that is not in contact with the first positive electrode and a second negative electrode that is not in contact with the first negative electrode, the second wound electrode assembly being wound around an outer periphery of the first wound electrode assembly about the first wound electrode assembly;
a case that houses the first wound electrode assembly and the second wound electrode assembly;
a positive electrode current collector member housed in the case, disposed on one side of the first wound electrode assembly and the second wound electrode assembly in an axial direction of the first wound electrode assembly, and electrically connected to both the first positive electrode and the second positive electrode; and
a negative electrode current collector member housed in the case, disposed on another side of the first wound electrode assembly and the second wound electrode assembly in the axial direction, and electrically connected to both the first negative electrode and the second negative electrode.

2. The energy storage cell according to claim 1, wherein:
the case includes a positive electrode terminal exposed to outside of the case and electrically connected to the positive electrode current collector member; and
the positive electrode current collector member includes
a first positive electrode connection portion connected to the first positive electrode,
a second positive electrode connection portion connected to the second positive electrode,
a terminal connection portion connected to the positive electrode terminal, and
a first fuse portion disposed in an electrically conductive path from the first positive electrode connection portion to the terminal connection portion in the positive electrode current collector member.

3. The energy storage cell according to claim 1, wherein:
the case includes a positive electrode terminal exposed to outside of the case and electrically connected to the positive electrode current collector member; and
the positive electrode current collector member includes
a first positive electrode connection portion connected to the first positive electrode,
a second positive electrode connection portion connected to the second positive electrode,
a terminal connection portion connected to the positive electrode terminal, and
a second fuse portion disposed in an electrically conductive path from the second positive electrode connection portion to the terminal connection portion in the positive electrode current collector member.

4. The energy storage cell according to claim 2, further comprising a second fuse portion disposed in an electrically conductive path from the second positive electrode connection portion to the terminal connection portion in the positive electrode current collector member, wherein:
the first fuse portion is provided so as not to be located on the electrically conductive path from the second positive electrode connection portion to the terminal connection portion in the positive electrode current collector member; and
the second fuse portion is provided so as not to be located on the electrically conductive path from the first positive electrode connection portion to the terminal connection portion in the positive electrode current collector member.

5. The energy storage cell according to claim 1, further comprising a tubular heat insulating member disposed between the first wound electrode assembly and the second wound electrode assembly in a radial direction of the first wound electrode assembly.
